(19) United States
(12) Patent Application Publication
(10) Pub. No.: US 2003/0161150 A1
(43) Pub. Date: Aug. 28, 2003

(54) Pipe-type lamp without a patterned frame

(76) Inventor: Chun-Ming Liu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,056

(22) Filed: Feb. 26, 2002

(51) Int. Cl. F21V 11/00

(52) U.S. Cl. 362/240; 362/250; 362/252

(57) ABSTRACT

The present invention relates to a pipe-type lamp without a patterned frame, which includes an inner tube being provided with several bulbs and connecting electrical wires inside and an outer tube. The characteristic of this invention is that the inner tube is provided an axial metal beam, which can be bent and patterned to form a stable structure that provides the pipe-type lamp having the same outlook for decorative effect easily without any superfluous frame.

### BACKGROUND OF THE INVENTION

A conventional pipe-type lamp (1) is always made of plastic material, as shown in FIGS. 1 and 2. It is composed by an inner tube (11), which is provided with several bulbs (2) and connecting electrical wire (21) and an outer tube (12) covering outside. In order to provide a special pattern for decoration, such as a triangular decoration in FIG. 3, a triangular frame (3) is needed for the conventional pipe-type lamp (1) to be tied around by a rope (31). A triangular decoration of the pipe-type lamp is then obtained that seems very trouble and inconvenient.

Accordingly, the primary object of the invention is to provide a novel pipe-type lamp having an inner metal beam, which can be patterned to form a stable structure without a patterned frame that increases decorative effect. Now the features and advantages of the present invention will be described in detail with reference to the accompanying drawings.

### BRIEF DESCRIPTION OF ACCOMPANYING DRAWINGS

FIG. 1 is a perspective view showing a conventional pipe-type lamp.

FIG. 2 is a partly cross-sectional plan view of FIG. 1.

FIG. 3 is a perspective view showing the conventional pipe-type lamp fixed on a patterned frame.

FIG. 4 is a perspective view showing a pipe-type lamp according to the present invention.

FIG. 5 is a partly cross-sectional plan view of FIG. 4 according to the present invention.

FIG. 6 is a perspective view showing an exemplary embodiment according to the present invention.

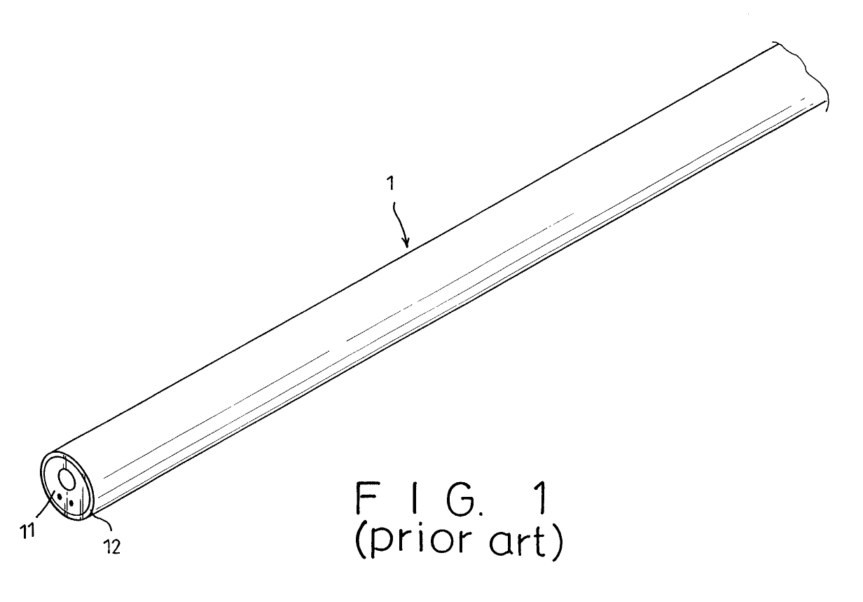

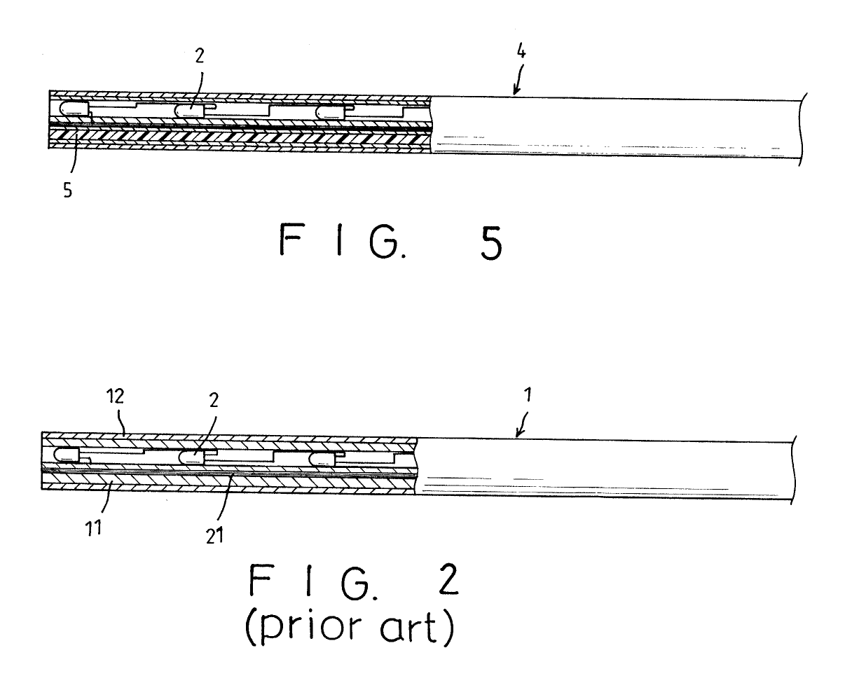

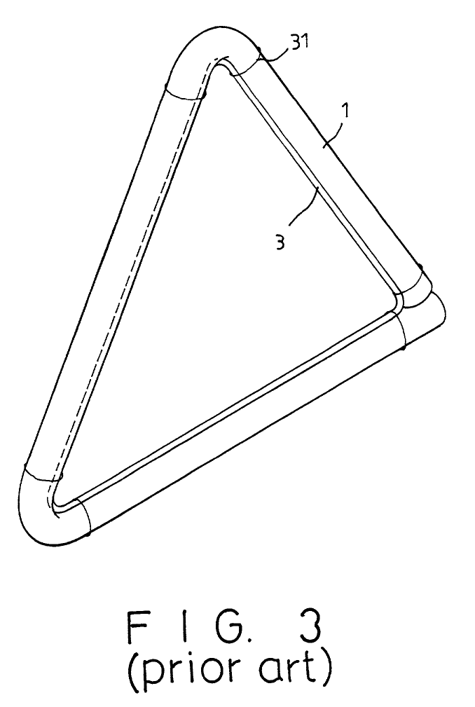

### DETAILED DESCRIPTION OF PREFERRED EMBODIMENTS

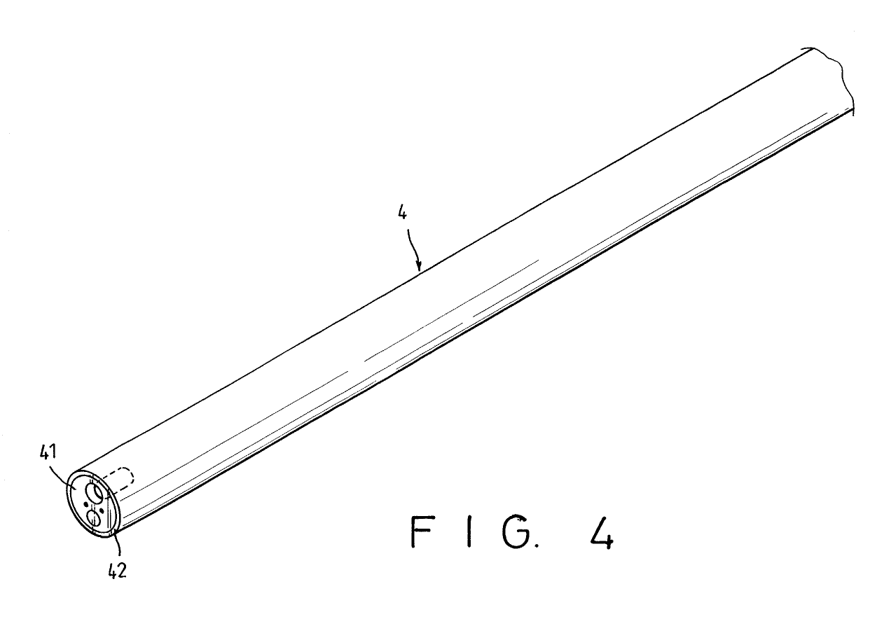

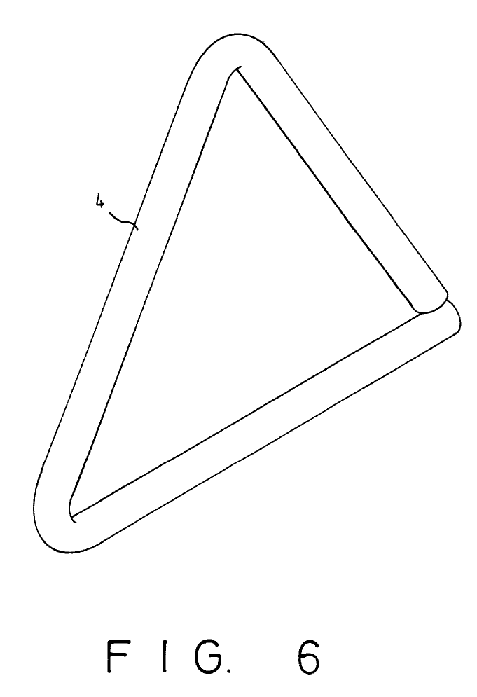

Please refer to FIG. 4 and 5, the present invention relates to an improvement of a pipe-type lamp (4) having an inner tube (41) covered by an outer tube (42). The characteristic is that the inner tube (41) is provided with an axial metal beam (5), which can be folded and patterned in a stable structure. So when the pipe-type lamp (4) is bent, as shown in FIG. 6, the lamp (4) becomes a triangular pattern due to the inner metal beam (5) will be patterned stably. It is known that any patterned frame will be unnecessary.

In application, the pipe-type lamp of the present invention can be patterned to form any other structure as desire, such a circular, a polygonal, or a star decoration. Based on the metal beam in the inner tube, the various decorative structures will be obtained in ease without a superfluous patterned frame.

Accordingly, the invented assembly of the present invention obviously obtains utility and improvement. It should be allowed for patent and is applied.

What is claimed is:

1. A pipe-type lamp without a patterned frame including an inner tube being provided with several bulbs and connecting electrical wires inside and an outer tube; the characteristic is that the inner tube is provided an axial metal beam, which can be bent and patterned to form a stable structure that provides the pipe-type lamp having the same outlook for decorative effect.

2. The pipe-type lamp without a patterned frame as claimed in claim 1, wherein the pipe-type lamp can be patterned to be a various structure without a patterned frame.
